(19) United States
(12) Patent Application Publication
(10) Pub. No.: US 2026/0328883 A1
(43) Pub. Date: Oct. 22, 2026

(54) UNDERWATER ACOUSTIC COMMUNICATION SYSTEM, CLOCK CALIBRATION METHOD, AND TRANSCEIVER

(71) Applicant: Furuno Electric Co., Ltd., Nishinomiya-City (JP)

(72) Inventor: Makoto IWAMOTO, Takarazuka (JP)

(73) Assignee: Furuno Electric Co., Ltd., Nishinomiya-City (JP)

(21) Appl. No.: 19/529,206

(22) Filed: Feb. 4, 2026

Related U.S. Application Data
(63) Continuation of application No. PCT/JP2025/000763, filed on Jan. 14, 2025.

(30) Foreign Application Priority Data
Feb. 14, 2024 (JP) 2024-020504

(51) Int. Cl. G01S 1/80; G01S 1/74; H04B 11/00

(52) U.S. Cl. CPC G01S 1/805; G01S 1/752; H04B 11/00; G01S 2201/07; G01S 2201/08

(57) ABSTRACT

An underwater acoustic communication system including a first and a second transceiver is disclosed. The first transceiver includes a clock and transmits a first ultrasonic message at a first point in time measured by the clock. The second transceiver receives the first message, acquires a second point in time at which the first message is received, calculates a one-way propagation time from the first to the second point in time, and transmits a second ultrasonic message including the one-way propagation time. The first transceiver further receives the second message, extracts the one-way propagation time from the second message, acquires a third point in time, measured by the clock, at which the second message is received, calculates a round-trip propagation time from the first to the third point in time, and adjusts a time of the clock based on the one-way propagation time and the round-trip propagation time.

### CROSS-REFERENCE TO RELATED APPLICATION(S)

This application is a continuation application of PCT International Application No. PCT/JP2025/000763, which was filed on Jan. 14, 2025, and which claims priority to Japanese Patent Application No. JP2024-020504 filed on Feb. 14, 2024, the entire disclosures of each of which are herein incorporated by reference for all purposes.

### TECHNICAL FIELD

The present disclosure relates to an underwater acoustic communication system, a clock calibration method, a transceiver, and a program.

### BACKGROUND

As one method of distance measurement in underwater acoustic positioning, there is the pinger method. The pinger method is a technique in which an ultrasonic message is transmitted from an underwater unit submerged in water, the ultrasonic message is received by a measurement unit mounted on a vessel, and a distance between the units is calculated from a time difference between reception time and transmission time.

In the pinger method, it is necessary to synchronize clocks of the underwater unit and the measurement unit so that errors do not occur.

A conventional technique for matching a reference time of the clock inside the underwater unit is to supply a synchronization signal to a connection cable suspended from the vessel and connected to the submerged underwater unit.

### SUMMARY

An underwater acoustic communication system according to one aspect of the present disclosure includes a first transceiver and a second transceiver. The first transceiver includes a clock, and the first transceiver is configured to transmit a first ultrasonic message at a first point in time measured by the clock. The second transceiver is configured to receive the first ultrasonic message, acquire a second point in time at which the first ultrasonic message is received, calculate a one-way propagation time from the first point in time to the second point in time, and transmit a second ultrasonic message comprising the one-way propagation time. The first transceiver is further configured to receive the second ultrasonic message, extract the one-way propagation time from the second ultrasonic message, acquire a third point in time, measured by the clock, at which the second ultrasonic message is received, calculate a round-trip propagation time from the first point in time to the third point in time, and adjust a time of the clock based on the one-way propagation time and the round-trip propagation time. This enables wireless clock calibration.

In the above configuration, the first transceiver may be placed on an underwater object, and the second transceiver may be further configured to calculate a position of the underwater object based on the one-way propagation time. The underwater object may comprise an unmanned underwater vehicle or a fishing net. This enables the position of the unmanned underwater vehicle or the fishing net to be calculated.

Furthermore, a clock calibration method of an underwater acoustic communication system including a first transceiver comprising a clock and a second transceiver, according to another aspect of the present disclosure, comprises transmitting a first ultrasonic message by the first transceiver at a first point in time measured by the clock; receiving the first ultrasonic message by the second transceiver; acquiring a second point in time at which the first ultrasonic message is received; calculating a one-way propagation time from the first point in time to the second point in time; transmitting by the second transceiver a second ultrasonic message; receiving the second ultrasonic message by the first transceiver; acquiring a third point in time, measured by the clock, at which the second ultrasonic message is received; calculating a round-trip propagation time from the first point in time to the third point in time; and adjusting a time of the clock based on the one-way propagation time and the round-trip propagation time. This enables wireless clock calibration.

Furthermore, a transceiver comprising a clock and included in an underwater acoustic communication system, according to another aspect of the present disclosure, comprises transmitting a first ultrasonic message at a first point in time measured by the clock; receiving a second ultrasonic message comprising a one-way propagation time from the first point in time to a second point in time at which the first ultrasonic message is received by another transceiver, the second ultrasonic message being transmitted by the other transceiver; extracting the one-way propagation time from the second ultrasonic message; acquiring a third point in time, measured by the clock, at which the second ultrasonic message is received; calculating a round-trip propagation time from the first point in time to the third point in time; and adjusting a time of the clock based on the one-way propagation time and the round-trip propagation time. This enables wireless clock calibration.

### BRIEF DESCRIPTION OF THE DRAWINGS

FIG. 1 is an example of an application of an underwater acoustic communication system.

FIG. 2 is a diagram showing an example configuration of the underwater acoustic communication system.

FIG. 3 is an illustration showing an example of operation of an underwater unit.

FIG. 4 is a continuation of FIG. 3.

FIG. 5 is an illustration showing an example of operation of a mother ship unit.

FIG. 6 is a diagram illustrating clock calibration.

FIG. 7 is a diagram illustrating clock calibration.

FIG. 8 is a diagram showing an example configuration of ultrasonic messages.

### DETAILED DESCRIPTION

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein.

In the disclosure, the circuitry, units, or means are hardware that carry out or are programmed to perform the recited functionality. The hardware may be any hardware disclosed herein or otherwise known which is programmed or configured to carry out the recited functionality.

When the hardware is a processor, which may be considered a type of circuitry, the circuitry, means, or units are a combination of hardware and software, the software being used to configure the hardware and/or processor.

Hereinafter, embodiments of the present disclosure will be described with reference to the drawings. In this specification and the drawings, the same reference numerals may be used for elements previously described in connection with prior drawings, and detailed descriptions may be omitted as appropriate.

Furthermore, in this specification, “time” refers to a period from one point in time to another point in time, and “point in time” refers to a specific point in time in the flow of time.

Clock calibration through a wired connection is not practical because an achievable calibration distance is limited and there is also concern about cable entanglement.

The present disclosure has been made in view of these issues, and its main purpose is to provide an underwater acoustic communication system, a clock calibration method, a transceiver, and a program capable of realizing wireless clock calibration.

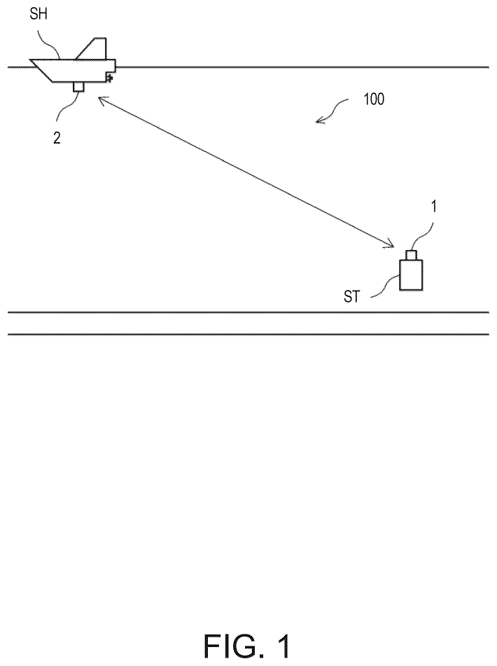

FIG. 1 is a schematic diagram showing an application example of an underwater acoustic communication system 100. The underwater acoustic communication system 100 comprises an underwater unit 1 and a mother ship unit 2.

The underwater unit 1 and the mother ship unit 2 realize underwater acoustic communication using ultrasonic waves and are capable of mutually transmitting and receiving ultrasonic messages. The underwater unit 1 is an example of a first transceiver. The mother ship unit 2 is an example of a second transceiver.

The underwater unit 1 is installed on an underwater object ST. The underwater object ST is, for example, an unmanned underwater vehicle or a fishing net. The mother ship unit 2 is installed on a vessel SH. The transceiver portion of the mother ship unit 2 protrudes downward from the bottom of the vessel SH. The mother ship unit 2 may be installed not only on the vessel SH but also, for example, on a buoy on the water surface or on a structure such as a pier.

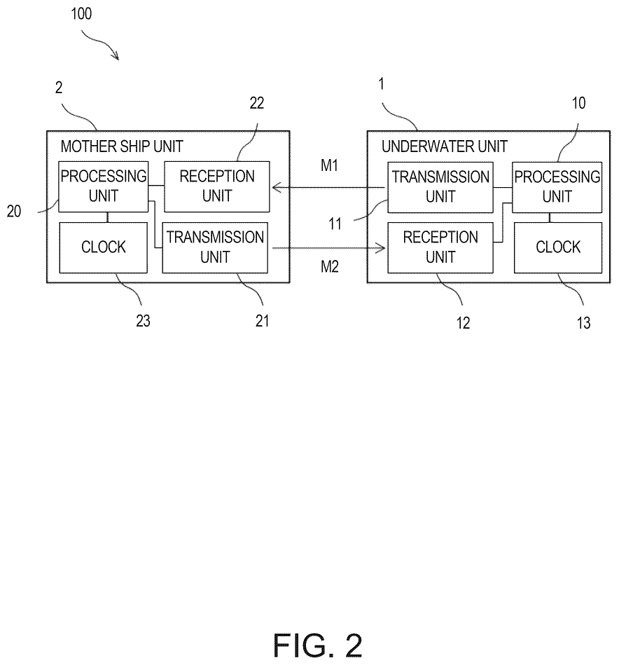

FIG. 2 is a block diagram showing an example configuration of the underwater unit 1 and the mother ship unit 2 included in the underwater acoustic communication system 100.

The underwater unit 1 is a computer including a processing unit 10, and further includes a transmission unit 11, a reception unit 12, and a clock 13. Similarly, the mother ship unit 2 is also a computer including a processing unit 20, and further includes a transmission unit 21, a reception unit 22, and a clock 23.

Each of processing units 10 and 20 is, for example, a CPU (Central Processing Unit) or an FPGA (Field Programmable Gate Array).

The transmission units 11 and 21 convert transmission signals into ultrasonic messages and emit the ultrasonic messages into water. The reception units 12 and 22 receive the ultrasonic messages propagating through the water and convert the ultrasonic messages into reception signals.

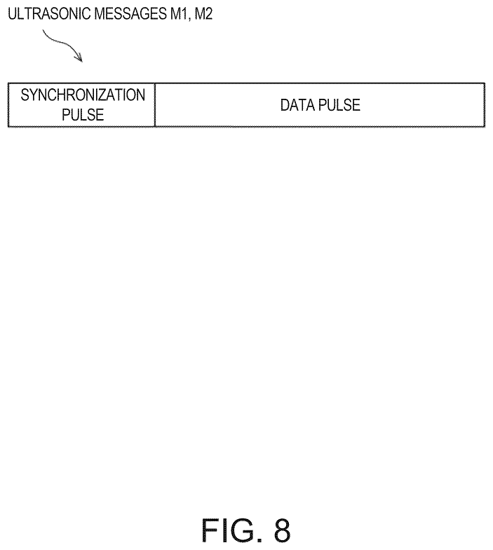

The ultrasonic message comprises a synchronization pulse and a data pulse (see FIG. 8), and the data pulse contains various information.

Each of clocks 13, 23 is, for example, an RTC (Real Time Clock). Alternatively, each of clocks 13, 23 may be a clock function of a CPU.

Note that the clock 23 of the mother ship unit 2 is not essential, and the processing unit 20 may acquire the point in time from another computer installed on the vessel SH, or may access an NTP (Network Time Protocol) server to acquire the point in time.

The underwater acoustic communication system 100 is capable of executing underwater acoustic positioning using the pinger method. That is, the mother ship unit 2 measures a propagation time of an ultrasonic message M1 (hereinafter also referred to as a pinger M1) propagating from the underwater unit 1 to the mother ship unit 2, and calculates a position of the underwater unit 1 based on the propagation time.

In this underwater acoustic positioning using the pinger method, it is necessary to periodically synchronize the clock 13 of the underwater unit 1 and the clock 23 of the mother ship unit 2 so that ranging accuracy does not decrease. Therefore, in this embodiment, calibration of the clock 13 of the underwater unit 1 is realized using the method described below.

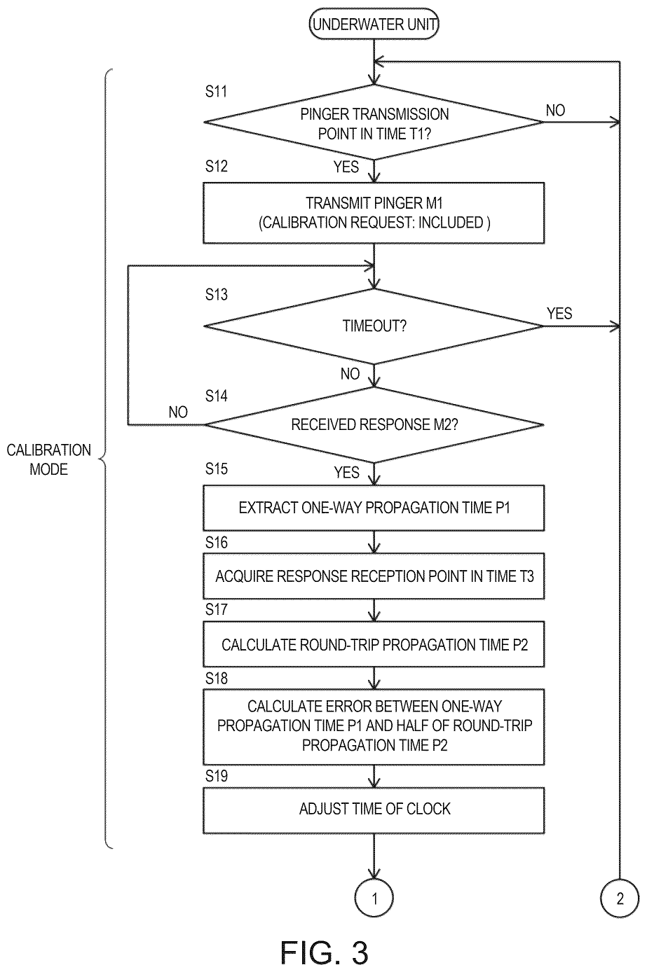

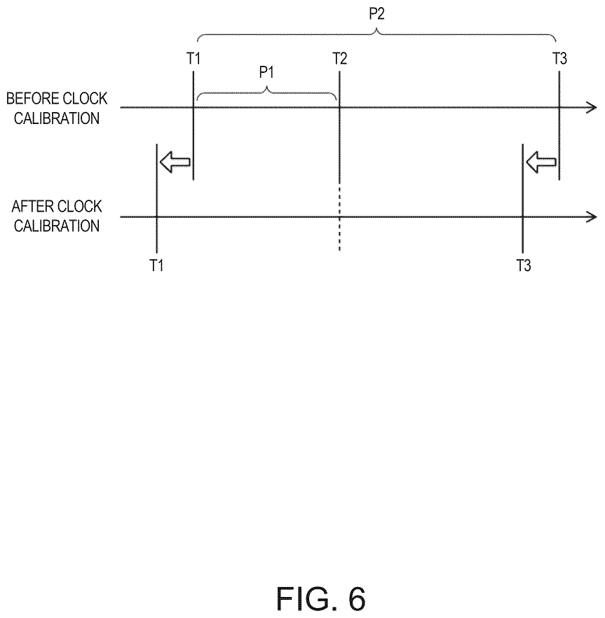

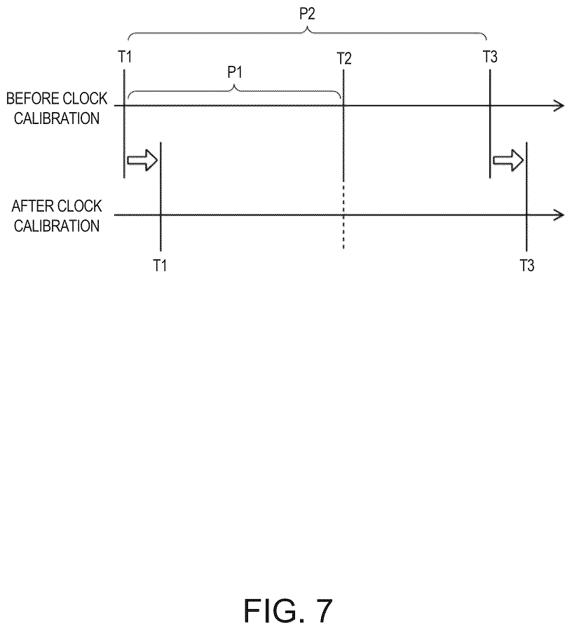

FIGS. 3 to 5 are flowcharts illustrating an example procedure of a clock calibration method realized in the underwater acoustic communication system 100. FIGS. 6 and 7 are diagrams showing examples of the clock calibration.

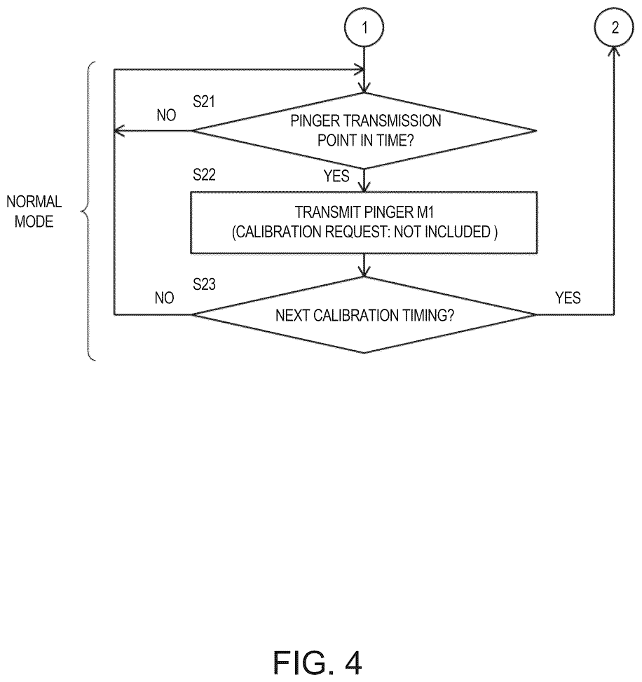

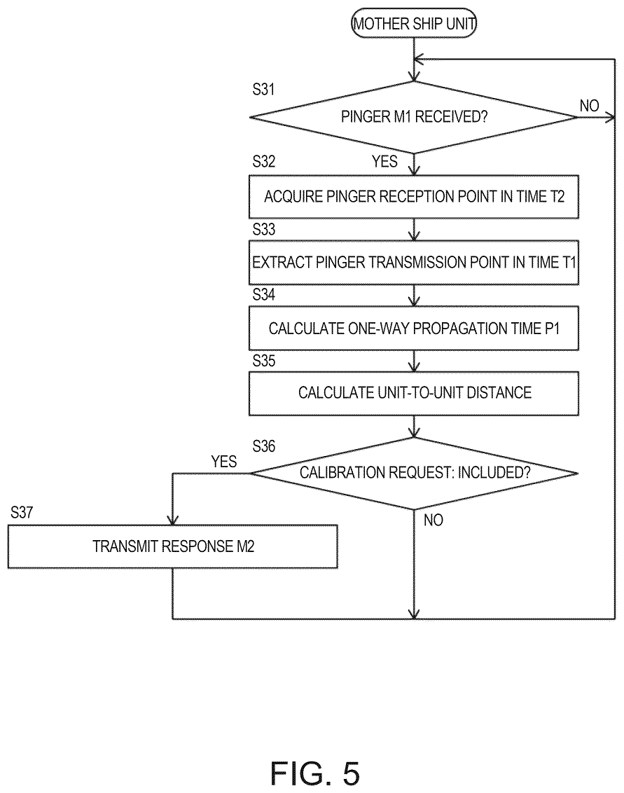

Among these, FIGS. 3 and 4 are flowcharts showing an example of operation of the underwater unit 1. The processing unit 10 of the underwater unit 1 executes information processing shown in these figures according to a program. FIG. 5 is a flowchart showing an example of operation of the mother ship unit 2. The processing unit 20 of the mother ship unit 2 executes information processing shown in this figure according to a program.

The underwater unit 1 executes a normal mode and a calibration mode. The calibration mode is executed at a given cycle (e.g., several minutes to several hundred minutes).

As shown in FIG. 4, in the normal mode, the underwater unit 1 transmits the pinger M1 (S22) each time a given pinger transmission point in time arrives (S21: YES). The pinger M1 transmitted in the normal mode does not contain a calibration request. The pinger M1 may include detection data such as water pressure detected by a sensor (not shown).

Then, when a calibration timing occurs next (S23: YES), the underwater unit 1 transitions from the normal mode to the calibration mode.

As shown in FIG. 3, in the calibration mode, when a given pinger transmission point in time T1 arrives (S11: YES), the underwater unit 1 transmits the pinger M1 (S12). The pinger M1 transmitted in the calibration mode includes a calibration request.

The pinger M1 includes a timestamp representing the pinger transmission point in time T1 measured by the clock 13. If the mother ship unit 2 has stored in advance the pinger transmission point in time T1, the pinger M1 may omit the timestamp representing the pinger transmission point in time T1.

As shown in FIG. 5, when the mother ship unit 2 receives the pinger M1 transmitted from the underwater unit 1 (S31: YES), it acquires a pinger reception point in time T2 at which the pinger M1 was received (S32).

In this embodiment, the pinger reception point in time T2 measured by the clock 23 of the mother ship unit 2 is acquired; however, this is not limited to this, and the pinger reception point in time T2 may also be acquired from outside the mother ship unit 2.

The pinger M1 is composed of a synchronization pulse and a data pulse (see FIG. 8). Normally, the point in time at which reception of the data pulse begins is detected. Therefore, when a reception time of the synchronization pulse is of a non-negligible magnitude, it is preferable to define the pinger reception point in time T2 as the point in time obtained by subtracting a value corresponding to the synchronization pulse reception time from the point in time at which reception of the data pulse begins.

Next, the mother ship unit 2 extracts the pinger transmission point in time T1 from the pinger M1 (S33). That is, the mother ship unit 2 demodulates the data pulse of the pinger M1 and acquires the pinger transmission point in time T1 contained in the timestamp. Note that the order of steps S32 and S33 may be reversed.

In this embodiment, the pinger transmission point in time T1 is extracted from the pinger M1; however, this is not limited to this, and if the pinger transmission point in time T1 has been stored in advance, it may be used.

Next, the mother ship unit 2 calculates a one-way propagation time P1 (=T2−T1) from the pinger transmission point in time T1 to the pinger reception point in time T2 (S34). The one-way propagation time P1 is the time required for the pinger M1 to propagate from the underwater unit 1 to the mother ship unit 2.

Next, the mother ship unit 2 calculates a distance between the underwater unit 1 and the mother ship unit 2 based on the calculated one-way propagation time P1 (S35). Specifically, the mother ship unit 2 calculates the distance between the units by multiplying the one-way propagation time P1 by the propagation speed of ultrasonic waves in water.

Furthermore, when the mother ship unit 2 is equipped with a plurality of reception units 22, it is also possible to calculate an azimuth of the underwater unit 1 relative to the mother ship unit 2 based on a difference in the points in time at which the plurality of reception units 22, arranged apart from each other in the horizontal direction, received the pinger M1.

Note that the calculation of the unit-to-unit distance (S35) may be performed only when the pinger M1 does not contain the calibration request (S36: NO), i.e., only when the pinger M1 transmitted in the normal mode is received.

The above-described series of processing, from transmitting the pinger M1 to calculating the unit-to-unit distance, is processing based on the pinger method. In this embodiment, in order to calibrate the clock 13 of the underwater unit 1, processing based on a transponder method described below is further executed.

When the mother ship unit 2 receives the pinger M1 that includes the calibration request (S36: YES), i.e., the pinger M1 transmitted in the calibration mode, it transmits an ultrasonic message M2 (hereinafter also referred to as a response M2) that includes the one-way propagation time P1 (S37).

In this embodiment, the one-way propagation time P1 is included in the response M2; however, this is not limited thereto, and the unit-to-unit distance may also be included in the response M2. As described above, since the unit-to-unit distance is based on the one-way propagation time P1, in that case as well, it can be said that the response M2 includes the one-way propagation time P1.

As shown in FIG. 3, when the underwater unit 1 receives the response M2 transmitted from the mother ship unit 2 (S14: YES), it extracts the one-way propagation time P1 from the response M2 (S15). That is, the underwater unit 1 demodulates the data pulse of the response M2 and acquires the one-way propagation time P1.

Next, the underwater unit 1 acquires a response reception point in time T3, measured by the clock 13, at which the response M2 was received (S16).

For the response M2 as well, when a reception time of the synchronization pulse is of non-negligible magnitude, it is preferable to determine the response reception point in time T3 by subtracting a value corresponding to the synchronization pulse reception time from the point in time at which reception of the data pulse begins.

Furthermore, for the response M2, since it is also necessary to consider a reception time of the pinger M1 (synchronization pulse reception time +data pulse reception time), it is preferable to determine the response reception point in time T3 by further subtracting a value corresponding to the reception time of the pinger M1.

Moreover, processing time from when the mother ship unit 2 receives the pinger M1 until it transmits the response M2 is ordinarily sufficiently small so as not to affect the clock calibration; however, when the processing time is of a non-negligible magnitude, it is preferable to also subtract a value corresponding to the processing time to determine the response reception point in time T3.

Next, the underwater unit 1 calculates a round-trip propagation time P2 (=T3−T1) from the pinger transmission point in time T1 to the response reception point in time T3 (S17). Note that the order of steps S15 and S16-17 may be reversed.

The round-trip propagation time P2 is the time required for the pinger M1 to propagate from the underwater unit 1 to the mother ship unit 2 and for the response M2 to propagate from the mother ship unit 2 to the underwater unit 1, i.e., the time required for the ultrasonic messages to make a round-trip between the underwater unit 1 and the mother ship unit 2.

Therefore, half of the round-trip propagation time P2 (=(T3−T1)/2) corresponds to the time required for the ultrasonic message to propagate one way between the underwater unit 1 and the mother ship unit 2. Such a round-trip propagation time P2 is a measured value used in the transponder method, which does not require clock calibration.

Next, the underwater unit 1 calculates an error between the one-way propagation time P1 (=T2−T1) and half of the round-trip propagation time P2 (=(T3-T1)/2) (S18).

Next, the underwater unit 1 adjusts a time of the clock 13 based on the calculated error (S19). Specifically, the underwater unit 1 adjusts the time of the clock 13 so that the one-way propagation time P1 becomes equal to half of the round-trip propagation time P2, i.e., so that the error becomes zero.

For example, as shown in FIG. 6, when the one-way propagation time P1 is smaller than half of the round-trip propagation time P2, since the time of the clock 13 is ahead of the clock 23 of the mother ship unit 2, the underwater unit 1 adjusts the time of the clock 13 backward.

On the other hand, as shown in FIG. 7, when the one-way propagation time P1 is greater than half of the round-trip propagation time P2, since the time of the clock 13 is behind that of the clock 23 of the mother ship unit 2, the underwater unit 1 advances the time of the clock 13.

In other words, the underwater unit 1 adjusts the time of the clock 13 so that the pinger reception point in time T2, measured by the clock 23 of the mother ship unit 2, is positioned at the center between the pinger transmission point in time T1 and the response reception point in time T3.

With this, the calibration mode by the underwater unit 1 ends. Thereafter, the underwater unit 1 returns to the normal mode.

Furthermore, in the calibration mode, when the pinger M1 including the calibration request has been transmitted (S12), if the response M2 is not received within a given time (S14: NO), the underwater unit 1 terminates the clock calibration, i.e., performs a so-called timeout (S13: YES).

According to the embodiment described above, wireless clock calibration can be achieved by adjusting the time of the clock 13 based on the one-way propagation time P1 and the round-trip propagation time P2.

That is, since the one-way propagation time P1 and the round-trip propagation time P2 are times measured using ultrasonic messages that propagated along the same path at the same speed at nearly the same time, the one-way propagation time P1 and half of the round-trip propagation time P2 should match, and when there is an error between the two, it means that the two clocks 13 and 23 are not synchronized. Therefore, by adjusting the time of clock 13 so that this error becomes zero, it is possible to synchronize the two clocks 13 and 23.

Furthermore, since this is a wireless clock calibration using ultrasonic messages, the clock calibration is possible during operation over ultrasonic propagation distances (e.g., several hundred to several thousand meters). It also eliminates the need for cumbersome tasks like cable connections. Additionally, because it uses ultrasonic messages propagated along the same path, calibration accuracy is not affected by changes in sound velocity with depth (including acoustic refraction).

The embodiments of the present disclosure have been described above; however, the present disclosure is not limited to the embodiments described above, and it goes without saying that various modifications are possible to those skilled in the art.

For example, the underwater unit 1 may correct a time adjustment amount of the clock 13 based on an amount of ultrasonic Doppler shift when the pinger M1 or the response M2 is received. According to this, even when the underwater unit 1 or the mother ship unit 2 is moving, it becomes possible to maintain the calibration accuracy.

That is, when the underwater unit 1 or the mother ship unit 2 moves, a difference arises between a forward propagation distance and a return propagation distance of the ultrasonic messages. Therefore, the Doppler amount is measured upon reception of the ultrasonic messages at both units, and the time adjustment amount is corrected in consideration of a variation of the propagation distances. The Doppler amount measured by the mother ship unit 2 is included in the response M2 and provided to the underwater unit 1.

In addition, part of the processing performed by the underwater unit 1 or the mother ship unit 2 may be executed by the other unit or by another computer. For example, the response M2 transmitted from the mother ship unit 2 may include the pinger reception point in time T2, and the underwater unit 1 may calculate the one-way propagation time P1.

Hereinafter, representative embodiments of the present disclosure are enumerated.

(1) An underwater acoustic communication system comprising:
a first transceiver comprising a clock, the first transceiver configured to transmit a first ultrasonic message at a first point in time measured by the clock; and
a second transceiver configured to:
   receive the first ultrasonic message,
   acquire a second point in time at which the first ultrasonic message is received,
   calculate a one-way propagation time from the first point in time to the second point in time, and
   transmit a second ultrasonic message comprising the one-way propagation time; wherein
the first transceiver is further configured to:
   receive the second ultrasonic message,
   extract the one-way propagation time from the second ultrasonic message,
   acquire a third point in time, measured by the clock, at which the second ultrasonic message is received,
   calculate a round-trip propagation time from the first point in time to the third point in time, and
   adjust a time of the clock based on the one-way propagation time and the round-trip propagation time.

(2) The underwater acoustic communication system of (1), wherein the first transceiver is configured to adjust the time of the clock based on a difference between the one-way propagation time and half the round-trip propagation time.

(3) The underwater acoustic communication system of (1) or (2), wherein the first transceiver is configured to adjust the time of the clock backward if the one-way propagation time is smaller than half the round-trip propagation time.

(4) The underwater acoustic communication system of any one of (1) to (3), wherein the first transceiver is configured to advance the time of the clock if the one-way propagation time is bigger than half the round-trip propagation time.

(5) The underwater acoustic communication system of any one of (1) to (4), wherein the first transceiver is configured to adjust the time of the clock so that the one-way propagation time equals half the round-trip propagation time.

(6) The underwater acoustic communication system of any one of (1) to (5), wherein
the first ultrasonic message comprises a timestamp representative of the first point in time, and
the second transceiver is further configured to extract the first point in time from the first ultrasonic message.

(7) The underwater acoustic communication system of any one of (1) to (6), wherein the second transceiver further comprises a clock and is configured to acquire the second point in time measured by the clock.

(8) The underwater acoustic communication system of any one of (1) to (7), wherein
the first ultrasonic message comprises a calibration request, and
the second transceiver is configured to transmit the second ultrasonic message if the first ultrasonic message comprises the calibration request.

(9) The underwater acoustic communication system of any one of (1) to (8), wherein the first transceiver is further configured to stop adjusting the time of the clock if the second ultrasonic message is not received within a given time after the first ultrasonic message is transmitted.

(10) The underwater acoustic communication system of any one of (1) to (9), wherein the second transceiver is further configured to calculate a distance between the first transceiver and the second transceiver based on the one-way propagation time.

(11) The underwater acoustic communication system of any one of (1) to (10), wherein the first transceiver is further configured to correct a time adjustment amount of the clock based on an amount of ultrasonic Doppler shift when the first ultrasonic message or the second ultrasonic message is received.

(12) The underwater acoustic communication system of any one of (1) to (11), wherein
the first transceiver is placed on an underwater object, and
the second transceiver is further configured to calculate a position of the underwater object based on the one-way propagation time.

(13) The underwater acoustic communication system of (12), wherein the underwater object comprises an unmanned underwater vehicle or a fishing net.

(14) A clock calibration method of an underwater acoustic communication system including a first transceiver comprising a clock and a second transceiver, the method comprising:
transmitting a first ultrasonic message by the first transceiver at a first point in time measured by the clock;
receiving the first ultrasonic message by the second transceiver;
acquiring a second point in time at which the first ultrasonic message is received;
calculating a one-way propagation time from the first point in time to the second point in time;
transmitting by the second transceiver a second ultrasonic message;
receiving the second ultrasonic message by the first transceiver;
acquiring a third point in time, measured by the clock, at which the second ultrasonic message is received;
calculating a round-trip propagation time from the first point in time to the third point in time; and
adjusting a time of the clock based on the one-way propagation time and the round-trip propagation time.

(15) A transceiver comprising a clock and included in an underwater acoustic communication system, the transceiver comprising:
transmitting a first ultrasonic message at a first point in time measured by the clock;
receiving a second ultrasonic message comprising a one-way propagation time from the first point in time to a second point in time at which the first ultrasonic message is received by another transceiver, the second ultrasonic message being transmitted by the other transceiver;
extracting the one-way propagation time from the second ultrasonic message;
acquiring a third point in time, measured by the clock, at which the second ultrasonic message is received;
calculating a round-trip propagation time from the first point in time to the third point in time; and
adjusting a time of the clock based on the one-way propagation time and the round-trip propagation time.

(16) A transceiver included in an underwater acoustic communication system, the transceiver comprising:
receiving a first ultrasonic message transmitted at a first point in time measured by a clock, the first ultrasonic message being transmitted by another transceiver comprising the clock;
acquiring a second point in time at which the first ultrasonic message is received;
calculating a one-way propagation time from the first point in time to the second point in time; and
transmitting a second ultrasonic message comprising the one-way propagation time.

(17) A non-transitory computer-readable medium having stored thereon computer-executable instructions which, when executed by a computer included in a transceiver with a clock in an underwater acoustic communication system, cause the computer to:
transmit a first ultrasonic message at a first point in time measured by the clock;
receive a second ultrasonic message comprising a one-way propagation time from the first point in time to a second point in time at which the first ultrasonic message is received by another transceiver, the second ultrasonic message being transmitted by the other transceiver;
extract the one-way propagation time from the second ultrasonic message;
acquire a third point in time, measured by the clock, at which the second ultrasonic message is received;
calculate a round-trip propagation time from the first point in time to the third point in time; and
adjust a time of the clock based on the one-way propagation time and the round-trip propagation time.

(18) A non-transitory computer-readable medium having stored thereon computer-executable instructions which, when executed by a computer included in a transceiver in an underwater acoustic communication system, cause the computer to:
receive a first ultrasonic message transmitted at a first point in time measured by a clock, the first ultrasonic message being transmitted by another transceiver comprising the clock;
acquire a second point in time at which the first ultrasonic message is received;
calculate a one-way propagation time from the first point in time to the second point in time; and
transmit a second ultrasonic message comprising the one-way propagation time.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. An underwater acoustic communication system comprising:
a first transceiver comprising a clock, the first transceiver configured to transmit a first ultrasonic message at a first point in time measured by the clock; and
a second transceiver configured to:
receive the first ultrasonic message,
acquire a second point in time at which the first ultrasonic message is received,
calculate a one-way propagation time from the first point in time to the second point in time, and
transmit a second ultrasonic message comprising the one-way propagation time; wherein
the first transceiver is further configured to:
receive the second ultrasonic message,
extract the one-way propagation time from the second ultrasonic message,
acquire a third point in time, measured by the clock, at which the second ultrasonic message is received,
calculate a round-trip propagation time from the first point in time to the third point in time, and
adjust a time of the clock based on the one-way propagation time and the round-trip propagation time.

2. The underwater acoustic communication system of claim 1, wherein
the first transceiver is configured to adjust the time of the clock based on a difference between the one-way propagation time and half the round-trip propagation time.

3. The underwater acoustic communication system of claim 1, wherein
the first transceiver is configured to adjust the time of the clock backward if the one-way propagation time is smaller than half the round-trip propagation time.

4. The underwater acoustic communication system of claim 1, wherein
the first transceiver is configured to advance the time of the clock if the one-way propagation time is bigger than half the round-trip propagation time.

5. The underwater acoustic communication system of claim 1, wherein
the first transceiver is configured to adjust the time of the clock so that the one-way propagation time equals half the round-trip propagation time.

6. The underwater acoustic communication system of claim 1, wherein
the first ultrasonic message comprises a timestamp representative of the first point in time, and
the second transceiver is further configured to extract the first point in time from the first ultrasonic message.

7. The underwater acoustic communication system of claim 1, wherein
the second transceiver further comprises a clock and is configured to acquire the second point in time measured by the clock.

8. The underwater acoustic communication system of claim 1, wherein
the first ultrasonic message comprises a calibration request, and
the second transceiver is configured to transmit the second ultrasonic message if the first ultrasonic message comprises the calibration request.

9. The underwater acoustic communication system of claim 1, wherein
the first transceiver is further configured to stop adjusting the time of the clock if the second ultrasonic message is not received within a given time after the first ultrasonic message is transmitted.

10. The underwater acoustic communication system of claim 1, wherein
the second transceiver is further configured to calculate a distance between the first transceiver and the second transceiver based on the one-way propagation time.

11. The underwater acoustic communication system of claim 1, wherein
the first transceiver is further configured to correct a time adjustment amount of the clock based on an amount of ultrasonic Doppler shift when the first ultrasonic message or the second ultrasonic message is received.

12. The underwater acoustic communication system of claim 1, wherein
the first transceiver is placed on an underwater object, and
the second transceiver is further configured to calculate a position of the underwater object based on the one-way propagation time.

13. The underwater acoustic communication system of claim 12, wherein
the underwater object comprises an unmanned underwater vehicle or a fishing net.

14. A clock calibration method of an underwater acoustic communication system including a first transceiver comprising a clock and a second transceiver, the method comprising:
transmitting a first ultrasonic message by the first transceiver at a first point in time measured by the clock;
receiving the first ultrasonic message by the second transceiver;
acquiring a second point in time at which the first ultrasonic message is received;
calculating a one-way propagation time from the first point in time to the second point in time;
transmitting by the second transceiver a second ultrasonic message;
receiving the second ultrasonic message by the first transceiver;
acquiring a third point in time, measured by the clock, at which the second ultrasonic message is received;
calculating a round-trip propagation time from the first point in time to the third point in time; and
adjusting a time of the clock based on the one-way propagation time and the round-trip propagation time.

15. A transceiver comprising a clock and included in an underwater acoustic communication system, the transceiver comprising:
transmitting a first ultrasonic message at a first point in time measured by the clock;
receiving a second ultrasonic message comprising a one-way propagation time from the first point in time to a second point in time at which the first ultrasonic message is received by another transceiver, the second ultrasonic message being transmitted by the other transceiver;
extracting the one-way propagation time from the second ultrasonic message;
acquiring a third point in time, measured by the clock, at which the second ultrasonic message is received;
calculating a round-trip propagation time from the first point in time to the third point in time; and
adjusting a time of the clock based on the one-way propagation time and the round-trip propagation time.
